(19) United States
(12) Patent Application Publication
(10) Pub. No.: US 2024/0227479 A1
(43) Pub. Date: Jul. 11, 2024

(54) MacBarringer Manned Aerial Vehicle Car (MB Mavcar)

(71) Applicant: Charles Edward Mack, Fredericksburg, VA (US)

(72) Inventor: Charles Edward Mack, Fredericksburg, VA (US)

(21) Appl. No.: 18/151,955

(22) Filed: Jan. 9, 2023

(51) Int. Cl. B60F 5/02; B60L 50/60; B60L 58/26; B64C 37/00; B64D 27/24; B64D 33/08

(52) U.S. Cl. CPC B60F 5/02; B60L 50/60; B60L 58/26; B64C 37/00; B64D 27/24; B64D 33/08; B60L 2200/10; B64D 2027/026

(57) ABSTRACT

A MB mavcar for road travel with an option for flight. The mb mavcar generally includes 1. Hybrid Gas/Electric vehicle. 2. Aerial Vehicle. 3. Collapsible, rotating propellers. The object of my invention is to provide an inexpensive electric or hybrid automobile of great strength and durability and to combine with a flying mechanism and appliances whereby the movements of the automobile may be completely under the control of the driver/pilot operator—that is to say, that the propulsion horizontally or at any desired angle with relation to the horizon or the gradual raising or lowering of the automobile or the turning of the same to any desired point of the compass, as well as hovering, may be entirely and completely within the control of the operator.

### PRIORITY CLAIM

This application is a continuation of and claims the benefit of U.S. application No. 63/362,025, filed Mar. 28, 2022. The entire disclosure of the foregoing application is incorporated by reference in the present application.

### TO ALL WHOM IT MAY CONCERN

BE IT KNOWN THAT I, Charles Edward. Mack, a citizen of the United States, has invented a new and useful MB mavcar (MacBarringer Manned Aerial Vehicle Car), an improvement in automobiles and I do hereby declare that the following is a full, clear, and exact description of the invention, which will enable others skilled in the art to which it appertains to make and use the same, reference being had to the accompanying drawings, and to the letters and figures of reference marked thereon, which form a part of this specification.

The object of my invention is to provide an inexpensive electric and/or hybrid automobile of great strength and durability and to combine with a flying mechanism and appliances whereby the movements of the automobile may be completely under the control of the driver/pilot operator—that is to say, that the propulsion horizontally or at any desired angle with relation to the horizon or the gradual raising or lowering of the automobile or the turning of the same to any desired point of the compass may be entirely and completely within the control of the operator.

### BACKGROUND

Example embodiments in general relate to flying drone cars and more specifically it relates to a MB mavcar for road travel with an option for flight. There is a need for transports to relieve traffic congestion in metropolitan areas and crowded interstate highways. Small aerial vehicles will be common in the near future for every day consumers. There is a need for an inexpensive, low maintenance alternative for the average consumer. The MB Mavcar is that alternative for personal transportation that will relieve the congestion on roadways.

### SUMMARY

An example embodiment of the present invention is directed to a flying drone car which includes 1. Hybrid Gas/Electric vehicle. 2. Aerial Vehicle. 3. Collapsible, rotating propellers. There has thus been outlined, rather broadly, some of the features of the MB mavcar in order that the detailed description thereof may be better understood, and in order that the present contribution to the art may be better appreciated. There are additional features of the MB mavcar that will be described hereinafter and that will form the subject matter of the claims appended hereto. In this respect, before explaining at least one embodiment of the MB mavcar in detail, it is to be understood that the MB mavcar is not limited in its application to the details of construction or to the arrangements of the components set forth in the following description or illustrated in the drawings. The MB mavcar is capable of other embodiments and of being practiced and carried out in various ways. Also, it is to be understood that the phraseology and terminology employed herein are for the purpose of the description and should not be regarded as limiting.

One object is to provide a MB mavcar for road travel with an option for flight.

Another object is to provide a MB Mavcar that the general population can afford.

Another object is to provide a MB Mavcar that is a manned aerial vehicle.

Another object is to provide a MB Mavcar that can assist the military.

Another object is to provide a MB Mavcar that will reduce road traffic congestion.

Other objects and advantages of the various embodiments of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### DETAILED DESCRIPTION

### A. Overview

Turning now descriptively to the drawings, in which similar reference characters denote similar elements throughout the several views, the figures illustrate an example embodiment comprising 1. Hybrid Gas/Electric vehicle. 2. Aerial Vehicle. 3. Collapsible, rotating propellers. This battery/gasoline operated vehicle for human transportation is capable of flight taking off and landing in a narrow area (Vertical Take-Off and Landing) and can be operated in the manner similar to that of a car. The vehicle has a gasoline/electric powered hybrid engine with an electrical circuit that powers the flying quadcopter mechanism and the land transportation mechanism (automobile). The quadcopter propellers are mounted and are pivotable about a pivot axis to allow the quadcopter to generate lift as well as movements in any direction to sustain flight. It takes off and lands like a drone. The Mavcar vehicle can accommodate two passengers. The manned aerial vehicle is guided by a digital controller to provide lift and directional control. This digital controller is a multi-directional joy stick with controls for forward, backward, left and right, with electronic speed controller with a gyro for the stabilizers in the propeller mounts. The battery source is a lithium power storage unit mounted and attached to the floor of the land transport (car), insulated by a firewall. This invention relates to the general prior art work of motor vehicles (automobiles) and flying quadcopter drones. THE APPLICANT CLAIMS THE BROADEST POSSIBLE LEGALLY VALID CLAIM FOR THE MB MAVCAR AND/OR INVENTION DESCRIBED IN THE ABSTRACT OF THE DISCLOSURE.

### B. Hybrid Gas/Electric Vehicle

The hybrid vehicle is structure with a battery pack to power the electronic propulsion of the vehicle. The gas will power the vehicle if the electric charge runs low. The vehicle will also charge the batteries while in use.

This vehicle has:
1. Induction Motor.
2. 16 module Lithium battery power source (pack).
3. Inverter.
4. Synchronized vehicle mechanism.
5. Internal permanent magnet synchronous reluctance motor.
6. Standard gas powered automobile combination.

The Mavcar could function totally by gas or electrical. The battery pack has lithium ion cells connected in a series and parallel. Are 16 detachable modules of 7,000 lithium ion cells. There is a glycol coolant radiator to cool the battery. There is an open gear box with a single transmission differential with two wheel axle and drive train. The regenerating braking system uses the induction motor to become a generator and creates electricity. IPM syn RM. Permanent magnets and syn RM—synchronous reluctance motor. An internal permanent magnet synchronous reluctance motor.

### C. Aerial Vehicle

The structure of the Aerial Vehicle is like a 4 propeller drone and its function is to allow the vehicle to fly.

There are sensors that help the Aerial Vehicle fly. The IMU is the internal measurement unit. The accel measures the linear force exerted on the quad propellers. Gyro measures the rotational motion of the quad propellers. The barometer tells the altitude based on atmospheric pressure. The voltmeter measures the battery voltages. The current sensor measures the current. The compass (magnetometer) tells the heading. The GNSS or GPS determines the position, speed and altitude.

A charger can be supplied. A dvr video receiver vrx can be added. A radio transmitter can be added to remotely control the aerial vehicle if a receiver is added. A HD camera can be added. A video transmitter can also be added.

### D. Collapsible, Rotating Propellers

The structure of the propellers is mounted upon a rotating mechanism which allows the propellers to rotate. The function is to rotate the propellers out of the way of traffic when the vehicle is in the driving mode.

On board computers control the quad propellers. Rotors turn the propellers creating thrust, torque and lift. There are 4 motors that are attached to the propellers. The mode 2 radio can control hoovering at 50% throttle. Can ascend and descend, pitch, roll and yaw. The propellers rotate clockwise to collapse on top of the car to make driving possible.

They can be controlled remotely. Can be made with various materials. They can be repositioned if performance can be increased. Different types and styles of propellers can be used.

### E. Connections of Main Elements and Sub-Elements of Invention

The gas tank is connected to the engine to provide an alternative when driving. The battery pack is connected to the motor and can be used to drive the car and/or fly the aerial vehicle. The engine is connected to the transmission to provide the power and rotation to drive the car. The battery pack is connected to the motor to drive the car and connected to the 4 motors attached to the propellers to control flight.

### F. Alternative Embodiments of Invention

The Mavcar can be operated as an unmanned aerial vehicle for reconnaissance in dangerous situations. It can be used as a taxi or as a delivery vehicle.

### G. Operation of Preferred Embodiment

The Mavcar operates and functions as a regular passenger automobile. In traffic jams the aerial vehicle controlled by the quad propellers can function and operate to make the vehicle take off vertically, hoover and fly over the traffic. The vehicle can seat one passenger. Produce 106 kw maximum output for 4 motors. 60 mph. 30 minutes of flight time.

Unless otherwise defined, all technical and scientific terms used herein have the same meaning as commonly understood by one of ordinary skill in the art to which this invention belongs. Although methods and materials similar to or equivalent to those described herein can be used in the practice or testing of the mb mavcar, suitable methods and materials are described above. All publications, patent applications, patents, and other references mentioned herein are incorporated by reference in their entirety to the extent allowed by applicable law and regulations. The mb mavcar may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

### INDEX OF ELEMENTS

10: Hybrid Gas/electric Vehicle
11: Induction Motor
12: 16 Module Lithium Battery Power Source (pack)
13: Inverter
14: Synchronized Vehicle Mechanism
15: Internal Permanent Magnet Synchronous Reluctance Motor
16: Standard Gas Powered Automobile Combination
20: Aerial Vehicle
21: Imu The Internal Measurement Unit
22: Accel
23: Gyro
24: Barometer
25: Voltmeter
26: Current Sensor
27: Compass (magnetometer)
28: Gnss Or Gps
30: Collapsible, Rotating Propellers
31: Rotating Mechanism
32: On Board Computers
33: Mode 2 Radio
34: Motor Mounts (braces)

### BRIEF DESCRIPTION OF THE DRAWINGS

Example embodiments will become more fully understood from the detailed description given herein below and the accompanying drawings, wherein like elements are represented by like reference characters, which are given by way of illustration only and thus are not limitative of the example embodiments herein.

FIG. 1: FIG. 1 is a top view of the present invention. This is the top view of the Mavcar in the driving mode.

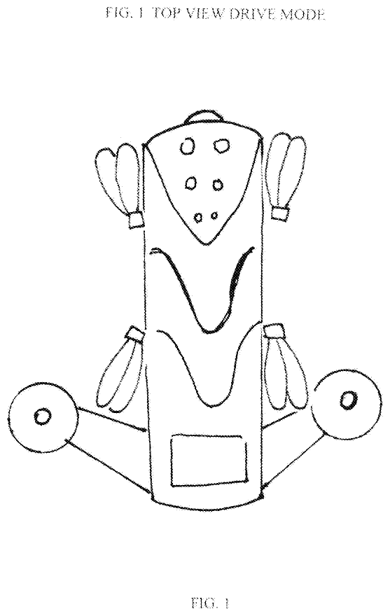

FIG. 2: FIG. 2 is a top view of the present invention. This is the top view of the Mavcar in the flying mode.

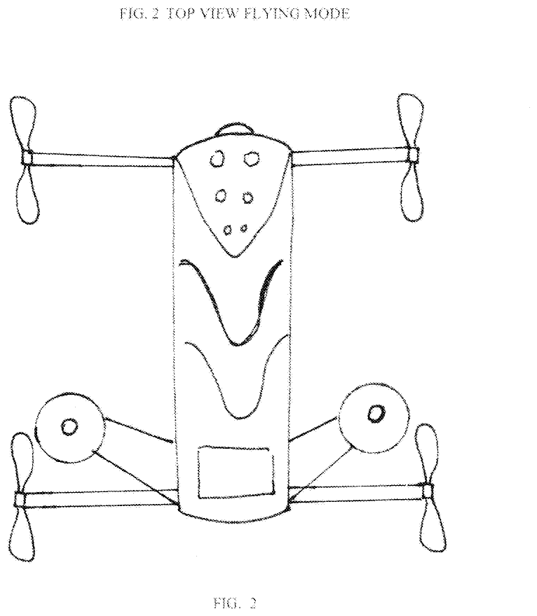

FIG. 3: FIG. 3 is a top view of the present invention. This is the top view of the lower carriage where the gas tank, battery pack, engine and motor are located.

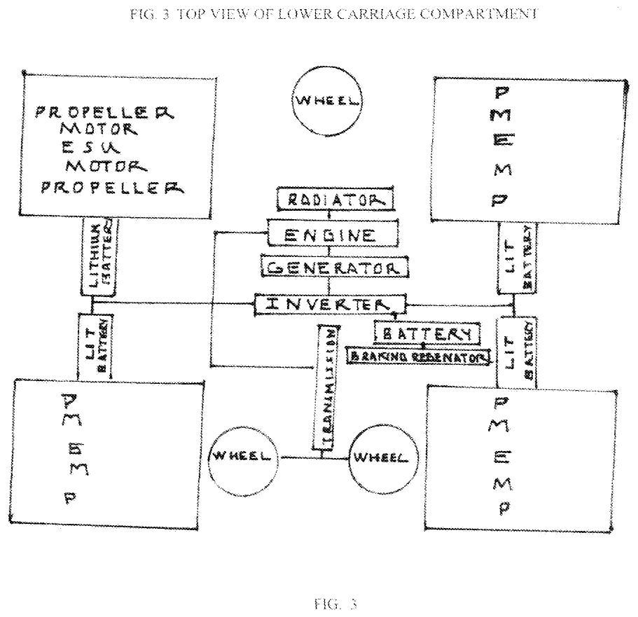

FIG. 4: FIG. 4 is a left side view of the present invention. This is the side view of the Mavcar's Cabin Compartment.

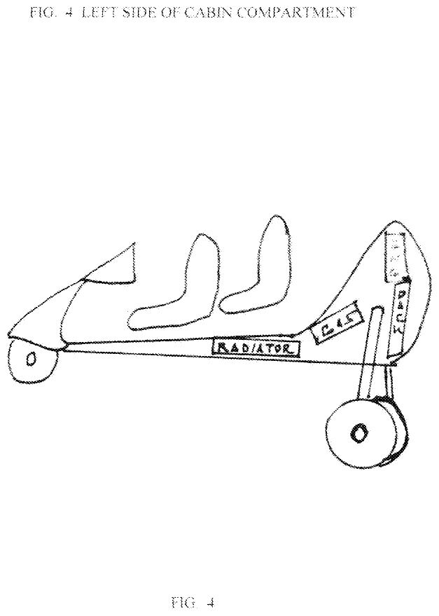

FIG. 5: FIG. 5 is a left side view of the present invention. This is the side view of the Mavcar in driving mode.

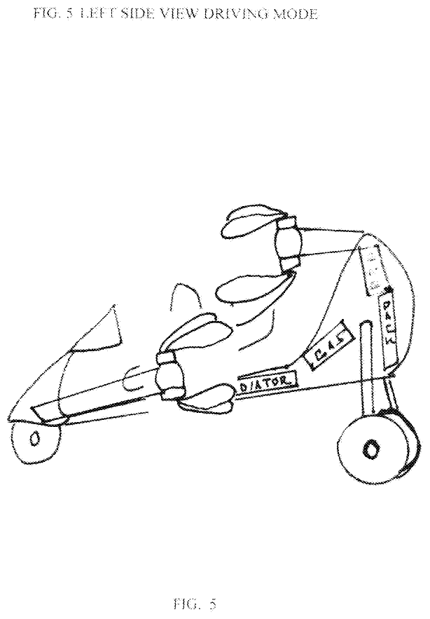

FIG. 6: FIG. 6 is a left side view of the present invention. This is the side view of the Mavcar in flying mode.

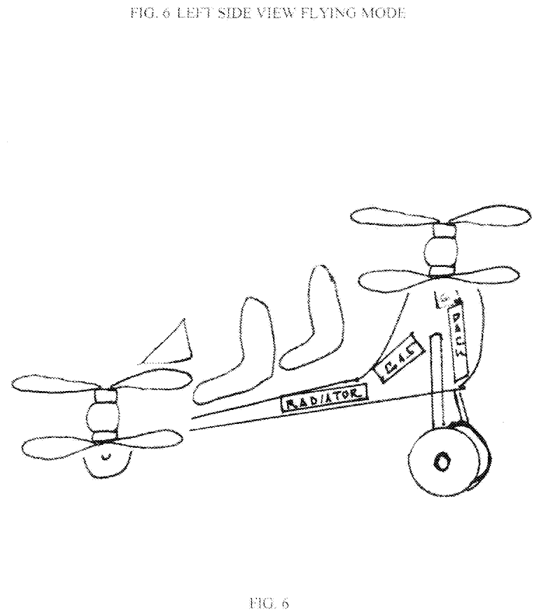

FIG. 7: FIG. 7 is a front view of the present invention. This is the front view of the Mavcar in the driving mode.

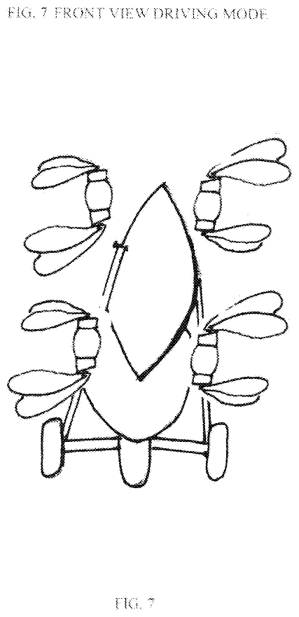

FIG. 8: FIG. 8 is a front view of the present invention. This is the front view of the Mavcar in the flying mode.

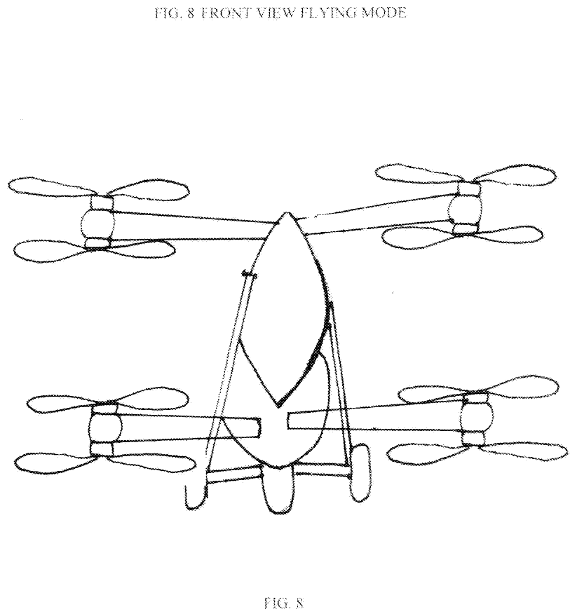

FIG. 9: FIG. 9 is a rear view of the present invention. This is the rear view of the Mavcar in the driving mode.

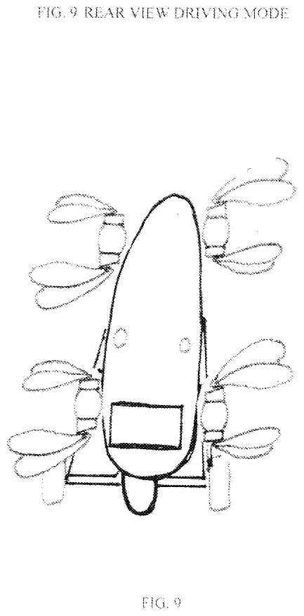

FIG. 10: FIG. 10 is a rear view of the present invention. This is the rear view of the Mavcar in the flying mode.

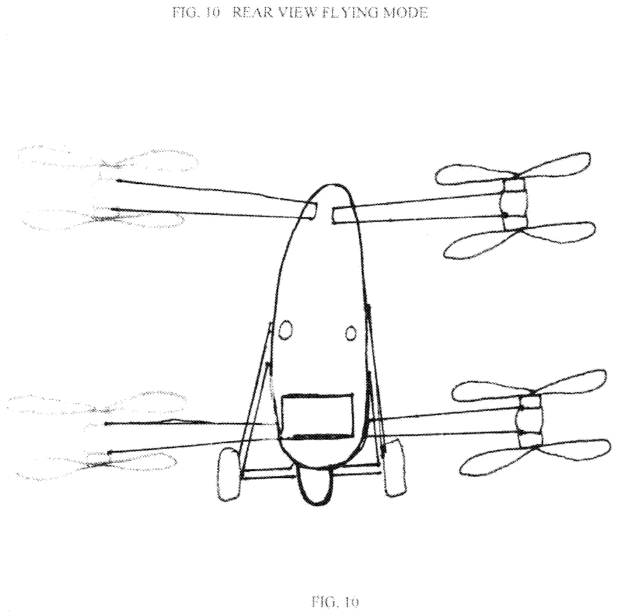

FIG. 11: FIG. 11 is an upper perspective view of the present invention. This is the perspective view of the Mavcar in driving mode.

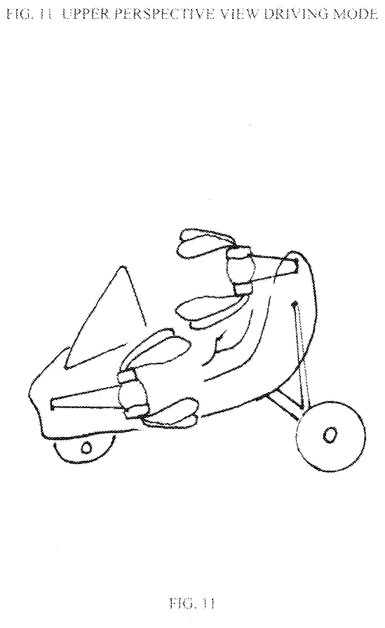

FIG. 12: FIG. 12 is an upper perspective view of the present invention. This is the perspective view of the Mavcar in the flying mode.

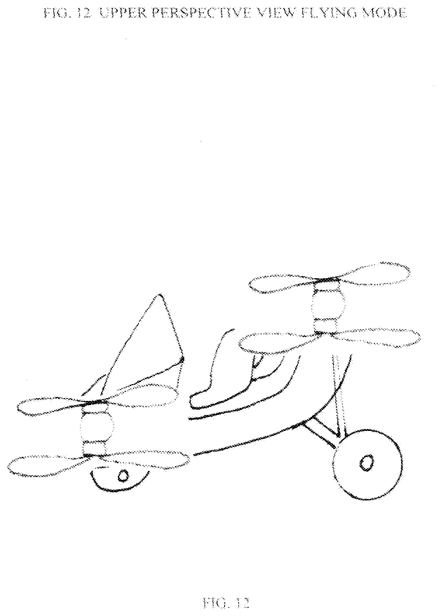

FIG. 13: FIG. 13 is an exploded upper perspective view of the present invention. This is an exploded view of the MavCar.

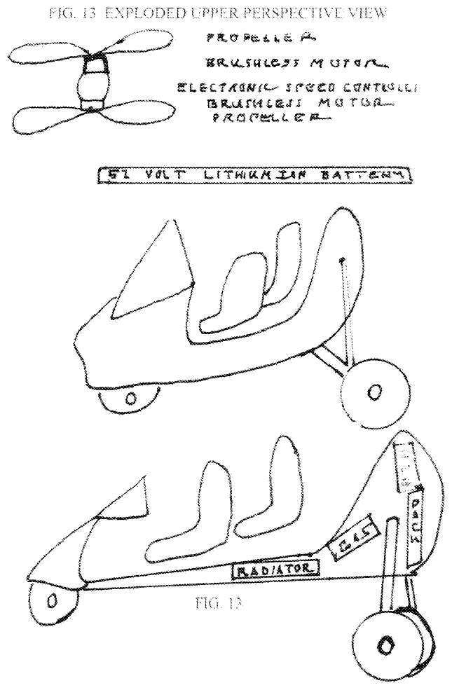

FIG. 14: FIG. 14 is a top view of the digital joy stick controller. This is a overhead view.

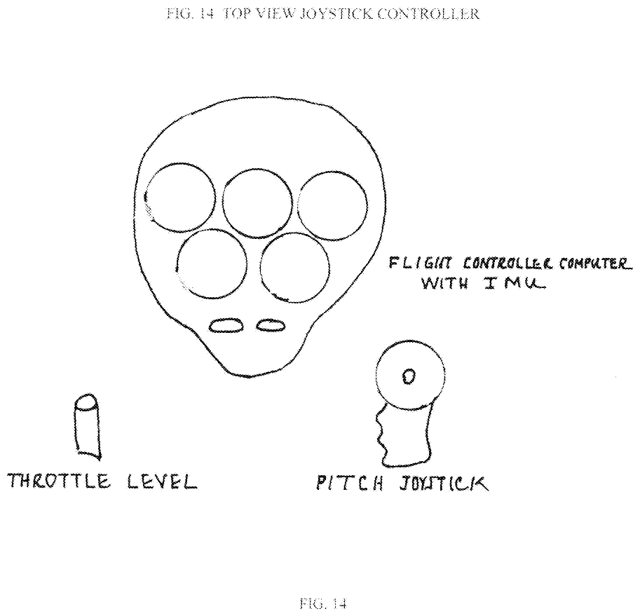

1. A vehicle comprising: a land transportation component; and an air transportation component.

2. A vehicle as in claim 1, wherein the land transportation component can operate using gasoline and/or electricity from a battery.

3. A vehicle as in claim 1, wherein the air transportation component operates using electricity from a battery.

4. A land transportation component as in claim 1, that is a motor vehicle comprising:
standard automobile elements.

5. An air transportation component as in claim 1, which is a fly vehicle comprising:
standard quadcopter drone elements.

6. A battery sufficient to supply an electrical drive unit to power both the land transportation and air transportation components as in claim 1.

7. A digital controller designed for the wireless transmission controls the air transportation component as in claim 1.

8. A cooling channel with cooling ribs which allow a cooling fluid and air to flow to cool the electrical energy battery as in claim 1.

9. The bottom of the passenger compartment as in claim 1, houses the electrical battery and energy storage unit.

10. The electrical battery and storage unit has a device by which electrical energy can be input into the electrical circuit of the quadcopter/air transportation component as in claim 1.
